(19) United States
(12) Patent Application Publication
(10) Pub. No.: US 2022/0236945 A1
(43) Pub. Date: Jul. 28, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: NAOKI SHIBUYA, TOKYO (JP); KEISUKE TOUYAMA, TOKYO (JP); SHINTARO MASUI, TOKYO (JP)

(21) Appl. No.: 17/609,450

(22) PCT Filed: Mar. 25, 2020
(86) PCT No.: PCT/JP2020/013349

§ 371 Date: Nov. 8, 2021

(30) Foreign Application Priority Data
May 16, 2019 (JP) 2019-093089

(51) Int. Cl. G06F 3/16; G10L 15/22

(52) U.S. Cl. CPC G06F 3/165; G06F 3/167; G10L 2015/223; G10L 2015/228; G10L 15/22

(57) ABSTRACT

An information processing device comprising: an ambiguity solving unit that generates music specifying information from information, which is included in utterance of a user and which includes ambiguity based on experience, by using sensing information related to the user; and a music determination unit that determines, on the basis of the music specifying information, at least one piece of music reproduction of which is estimated to be instructed by the utterance by the user.

### FIELD

The present disclosure relates to an information processing device, an information processing method, and a program.

### BACKGROUND

Recently, an agent system such as a smart speaker or a personal assistant that executes a task on the basis of an interaction with a user in natural language has been developed. Thus, importance of a voice user interface (UI) that is a standard interface in such an agent system is increasing.

Also, as a service having a high affinity with the agent system using the voice UI, a music streaming service that reproduces music selected from a music database or the like on the basis of an instruction from the user in the natural language has been developed.

However, the agent system using the voice UI gives the user feeling of having an interaction with a human. Thus, the instruction from the user in the natural language may be a sensuous and ambiguous instruction.

Thus, for example, a technology of recommending more appropriate content according to a situation of a user on the basis of information regarding a reaction of the user and a surrounding environment of when the content is viewed in the past, and information related to the content itself in a system of recommending content such as music is disclosed in Patent Literature 1 in the following.

### CITATION LIST

### Patent Literature

Patent Literature 1: Japanese Patent Application Laid-open No. 2010-262436

### SUMMARY

### Technical Problem

However, the technology disclosed in Patent Literature 1 described above is to determine content considered to be requested by the user from a situation or the like of the user, and is not to solve ambiguity included in utterance of the user and clarify contents of an instruction by the utterance.

Thus, the present disclosure proposes a new and improved information processing device, information processing method, and program that can clarify what is meant by an expression including ambiguity in the utterance of the user, and can determine music reproduction of which is estimated to be instructed by the user.

### Solution to Problem

According to the present disclosure, an information processing device is provided that includes: an ambiguity solving unit that generates music specifying information from information, which is included in utterance of a user and which includes ambiguity based on experience, by using sensing information related to the user; and a music determination unit that determines, on the basis of the music specifying information, at least one piece of music reproduction of which is estimated to be instructed by the utterance by the user.

Moreover, according to the present disclosure, an information processing method is provided that includes: generating music specifying information from information, which is included in utterance of a user and which includes ambiguity based on experience, by using sensing information related to the user; and determining, on a basis of the music specifying information, at least one piece of music reproduction of which is estimated to be instructed by the utterance by the user, the generating and determining being performed by an arithmetic device.

Moreover, according to the present disclosure, a program is provided that causes a computer to function as an ambiguity solving unit that generates music specifying information from information, which is included in utterance of a user and which includes ambiguity based on experience, by using sensing information related to the user, and a music determination unit that determines, on a basis of the music specifying information, at least one piece of music reproduction of which is estimated to be instructed by the utterance by the user.

### BRIEF DESCRIPTION OF DRAWINGS

FIG. 1 is a view for describing an outline of an information processing system according to an embodiment of the present disclosure.

FIG. 2 is a block diagram for describing functional configurations of an information processing device and a terminal device included in the information processing system according to the embodiment.

FIG. 3 is a flowchart illustrating a flow of an overall operation of the information processing system according to the embodiment.

FIG. 4 is a flowchart illustrating a specific flow of ambiguity solving processing illustrated in FIG. 3.

FIG. 5 is a flowchart illustrating a specific flow of music determination processing illustrated in FIG. 3.

FIG. 6 is a block diagram illustrating an example of a hardware configuration in the information processing device included in the information processing system according to the embodiment.

### DESCRIPTION OF EMBODIMENTS

In the following, preferred embodiments of the present disclosure will be described in detail with reference to the accompanying drawings. Note that the same reference signs are assigned to components having substantially the same functional configuration, and overlapped description is omitted in the present specification and the drawings.

Note that the description will be made in the following order.

1. Outline of information processing system

2. Configuration of information processing device

3. Modification example

4. Operation of information processing device

4.1. Overall operation

4.2. Operation of ambiguity solving processing

4.3. Operation of music determination processing

5. Configuration of hardware

<1. Outline of Information Processing System>

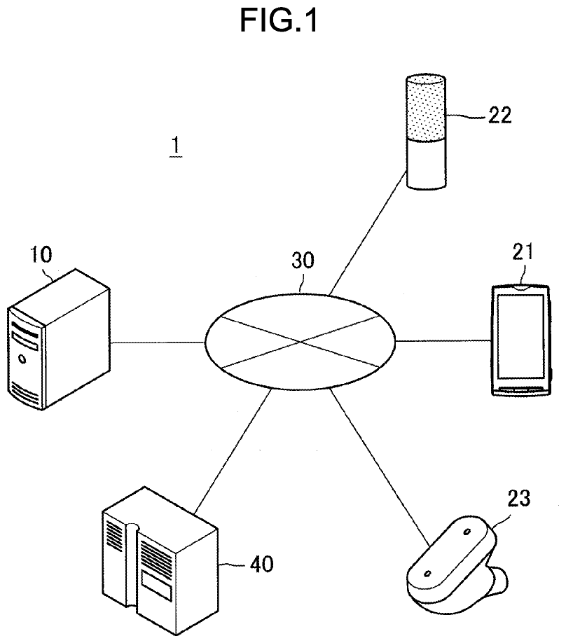

First, an outline of an information processing system according to an embodiment of the present disclosure will be described with reference to FIG. 1. FIG. 1 is a view for describing the outline of the information processing system according to the present embodiment.

As illustrated in FIG. 1, the information processing system 1 according to the present embodiment includes, for example, an information processing device 10, a smartphone 21, a smart speaker 22, an earphone 23, or the like (also collectively referred to as terminal device 20), and a database server 40 connected to each other via a network 30.

The terminal device 20 (that is, smartphone 21, smart speaker 22, or earphone 23) is a device that inputs and outputs information to and from a user by using a voice UI. Specifically, the terminal device 20 can acquire utterance of the user by using a microphone or the like, and transmit a sound signal based on the acquired uttered voice to the information processing device 10. Also, by using a headphone or a speaker, the terminal device 20 can convert the sound signal generated by the information processing device 10 into sound and perform an output thereof to the user.

Also, the terminal device 20 reproduces music on the basis of an instruction from the information processing device 10. Specifically, the terminal device 20 reproduces music stored therein or music stored in the database server 40 on the basis of the instruction from the information processing device 10. Here, the music to be reproduced by the terminal device 20 on the basis of the instruction from the information processing device 10 is music reproduction of which is instructed to the terminal device 20 by the utterance by the user.

Note that the terminal device 20 may be the smartphone 21, the smart speaker 22, the earphone 23, or the like in the manner illustrated in FIG. 1. However, the form of the terminal device 20 is not limited to such an example. The terminal device 20 may be, for example, a cell phone, tablet terminal, personal computer (PC), game machine, wearable terminal (such as smart eyeglass, smart band, smart watch, or smart neck band), or a robot imitating a human, various animals, various characters, or the like.

The network 30 is a wired or wireless transmission network that transmits/receives information. For example, the network 30 may be a public network such as the Internet, a telephone network, or a satellite communication network, various local area networks (LAN) including Ethernet (registered trademark), or a transmission network including a wide area network (WAN) and the like. Also, a network 920 may be a transmission network including a dedicated network such as the Internet protocol-virtual private network (IP-VPN) and the like.

The database server 40 is, for example, an information processing server that stores many pieces of music as a database. The database server 40 outputs, to the terminal device 20, sound information of the music reproduced by the terminal device 20. For example, the database server 40 may be an information processing server for a music streaming service which server outputs the sound information of the music in response to a request from the terminal device 20 or the like.

On the basis of contents of the utterance of the user which utterance is acquired by the terminal device 20, the information processing device 10 determines music reproduction of which is estimated to be instructed by the user. Specifically, by performing speech recognition of the utterance of the user which utterance is acquired by the terminal device 20, and by semantically analyzing the contents of the utterance on which the speech recognition is performed, the information processing device 10 determines the music reproduction of which is estimated to be instructed by the user.

Specifically, according to the technology of the present disclosure, in a case where information including ambiguity based on experience of the user is included in the contents of the utterance of the user, by using life-log information of the user, the information processing device 10 can generate information to specify music from the information including the ambiguity. Thus, even in a case where the user does not clearly instruct music to be reproduced, the information processing device 10 can determine the music reproduction of which is estimated to be instructed by the user from the information included in the utterance of the user.

Here, the life-log information of the user represents an information group in which various kinds of sensing information related to the user are accumulated. Specifically, the life-log information of the user may be an information group in which a history of at least one of information related to a position of the user, information related to behavior of the user, or information related to an environment around the user is accumulated. Such life-log information of the user can be acquired, for example, by the terminal device 20, an information processing terminal such as a smartphone carried by the user, a sensor such as an imaging device that senses a space in which the user is present, or the like. Furthermore, the life-log information of the user may include a post to a social networking service (SNS) by the user, or the like.

<2. Configuration of Information Processing Device>

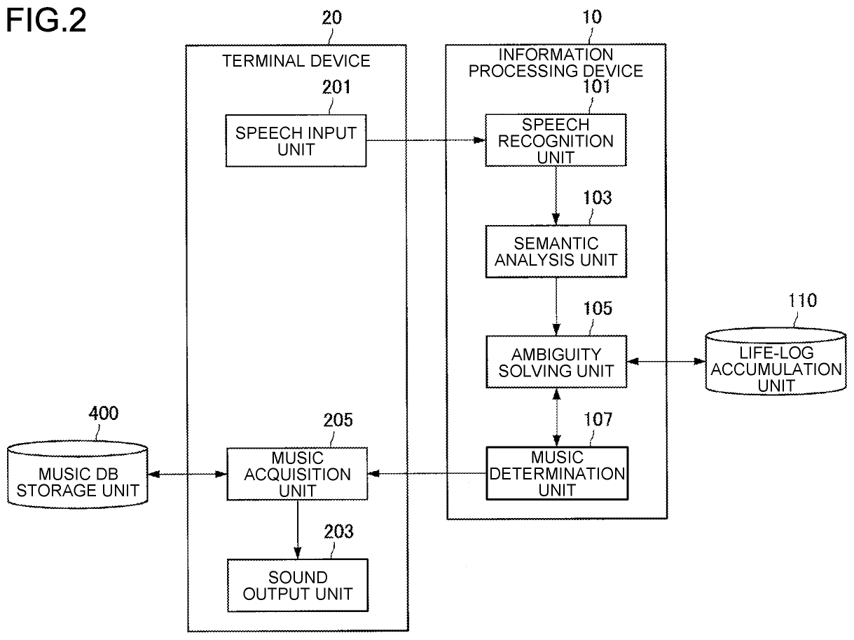

Next, a specific configuration of the information processing device 10 included in the information processing system 1 according to the present embodiment will be described with reference to FIG. 2. FIG. 2 is a block diagram for describing functional configurations of the information processing device 10 and the terminal device 20 included in the information processing system 1 according to the present embodiment.

As illustrated in FIG. 2, the terminal device 20 includes, for example, a speech input unit 201, a music acquisition unit 205, and a sound output unit 203. Also, the information processing device 10 includes, for example, a speech recognition unit 101, a semantic analysis unit 103, an ambiguity solving unit 105, and a music determination unit 107. As described above, the terminal device 20 and the information processing device 10 are connected to each other directly or via the network 30.

(Terminal Device 20)

The speech input unit 201 includes an acoustic device such as a microphone that acquires sound, and a conversion circuit that converts the acquired sound into a sound signal. Thus, the speech input unit 201 can convert sound of the utterance of the user into the sound signal.

The sound signal of the utterance of the user is output to the speech recognition unit 101 of the information processing device 10 via the network 30 or the like, for example. Then, information related to music reproduction of which is instructed by the utterance of the user is output to the terminal device 20 from the music determination unit 107 of the information processing device 10.

The music acquisition unit 205 acquires sound information of the music reproduction of which is instructed by the utterance of the user. Specifically, from a music DB storage unit 400, or a storage unit (not illustrated) in the terminal device 20, the music acquisition unit 205 acquires the sound information of the music reproduction of which is instructed by the utterance of the user.

The music DB storage unit 400 is a storage unit that stores, as a database, sound information of many pieces of music. The music DB storage unit 400 may include, for example, a magnetic storage device such as a hard disk drive (HDD), a semiconductor storage device, an optical storage device, a magneto-optical storage device, or the like. The music DB storage unit 400 may be provided in the database server 40 outside the terminal device 20, or may be provided inside the terminal device 20.

The sound output unit 203 includes an acoustic device such as a speaker or headphone that converts the sound signal into sound. Thus, the sound output unit 203 can convert the sound signal of the music acquired by the music acquisition unit 205 into an audible sound and perform an output thereof to the user.

(Information Processing Device 10)

By performing speech recognition on the utterance of the user which utterance is acquired by the terminal device 20, the speech recognition unit 101 generates character information of the utterance. Specifically, by comparing a feature of sound included in the sound information of the utterance of the user with a feature of a phoneme of each character, the speech recognition unit 101 can generate, as character information of the utterance, a character string that generates sound information that is the closest to the sound information of the utterance of the user. More specifically, by using an acoustic model representing a frequency characteristic of each of phonemes of a recognition object and a language model representing restriction on an alignment of the phonemes, the speech recognition unit 101 can generate, as the character information of the utterance, the character string that is the closest to the sound information of the utterance of the user. For example, from an analog signal of the uttered voice of the user, the speech recognition unit 101 can generate text information in which phonemes included in the utterance of the user are represented by a character string of katakana or the like.

Alternatively, the speech recognition unit 101 may generate character information indicating contents of the utterance by performing speech recognition of the utterance of the user by using a machine learning technique such as deep learning. Furthermore, the speech recognition unit 101 may generate the character information indicating the contents of the utterance by performing speech recognition of the utterance of the user by using a known speech recognition technology.

The semantic analysis unit 103 understands meaning of the utterance of the user by analyzing the character information indicating the contents of the utterance of the user, and generates semantic information of the utterance on the basis of the understood result. Specifically, first, the semantic analysis unit 103 decomposes the character information indicating the contents of the utterance into words for each part of speech by word decomposition, and analyzes a sentence structure from part-of-speech information of the decomposed words. Then, by referring to meaning of each word included in the utterance of the user, and the analyzed sentence structure, the semantic analysis unit 103 can generate the semantic information indicated by the utterance of the user. For example, from text information in which contents of the utterance of the user is represented by a character string, the semantic analysis unit 103 can generate semantic information indicating an instruction, command, or request from the user to the terminal device 20 or the information processing device 10.

Alternatively, by analyzing character information indicating contents of the utterance of the user by using a machine learning technique such as deep learning, the semantic analysis unit 103 may generate semantic information indicated by the utterance of the user. Furthermore, the semantic analysis unit 103 may generate semantic information, which is indicated by the utterance of the user, by analyzing character information indicating the contents of the utterance of the user by using a known semantic analysis technology.

The ambiguity solving unit 105 generates music specifying information from information that includes ambiguity based on experience of the user and that is included in the semantic information indicated by the utterance of the user.

The agent system that uses the voice UI and that is realized by the information processing system 1 according to the present embodiment can give the user feeling of having an interaction with a human. Thus, the utterance of the user may include an ambiguous expression or instruction based on implicit common knowledge possessed by humans. For example, the utterance of the user may include an abbreviated name or nickname of a title name or artist name of music, may include designation of music by an atmosphere or the like, or may include designation of music by related information such as tie-up information.

Specifically, in a case where the ambiguous expression is based on personal experience of the user, it is difficult to determine contents meant by such an ambiguous expression from general knowledge or related information. For example, an instruction from the user by utterance such as “please play the theme song of the drama I watched yesterday”, “please play the song played in the previous cafe”, “I want to listen to the song played in the ski resort in December last year”, or “please play the song sung at the beginning of the live show last month” specifies the music to be reproduced in association with personal experience or the like of the user. Thus, it is difficult to generally interpret contents meant by the instruction.

By referring to the life-log information of the user and interpreting the contents meant by the above-described ambiguous expression based on the experience of the user, the ambiguity solving unit 105 can generate information to specify the music reproduction of which is estimated to be instructed by the user.

Specifically, the life-log information of the user is an information group in which a history of at least one of information related to a position of the user, information related to behavior of the user, or information related to an environment around the user is accumulated.

Examples of the information related to the position of the user include, for example, positional information of the user from a global navigation satellite system (GNSS), positional information of the user which information is determined from a base station or the like of a mobile communication network or Wi-Fi (registered trademark), and geographical category (such as station, supermarket, home, or workplace) information of a location of the user. Examples of the information related to the behavior of the user include, for example, information related to a transportation means of the user (such as “walking”, “running”, “riding a bicycle”, “driving a car”, or “riding a train”) and information related to high-context behavior of the user (such as “working”, “shopping”, “commuting”, or “watching TV”). Examples of the information related to the environment around the user include, for example, sound or video information of the environment around the user, and information related to a temperature, humidity, or illuminance of the environment around the user.

The above-described life-log information of the user can be stored, for example, in a life-log accumulation unit 110 provided outside or inside the information processing device 10. The life-log accumulation unit 110 may include, for example, a magnetic storage device such as a hard disk drive (HDD), a semiconductor storage device, an optical storage device, a magneto-optical storage device, or the like. The life-log information to be stored in the life-log accumulation unit 110 may be acquired within a range permitted by the user, for example, from at least one of the terminal device 20, a wearable terminal carried by the user, a mobile terminal such as a smartphone or cell phone, a monitoring camera that senses a space in which the user is present, an external network service such as a social networking service (SNS), or the like.

This enables the ambiguity solving unit 105 to generate music specifying information to determine the music, reproduction of which is estimated to be instructed by the user, from the information that includes ambiguity based on the experience of the user and that is included in the utterance of the user. Specifically, from the information that includes the ambiguity and that is included in the utterance of the user, the ambiguity solving unit 105 can generate music specifying information to specify a situation in which the user has listened to the music reproduction of which is estimated to be instructed by the user. More specifically, from the information including the ambiguity based on the experience of the user, the ambiguity solving unit 105 can generate music specifying information to specify any one or more of a date and time, place, environment, and behavior performed by the user of when the user has listened to the music.

Furthermore, in a case where any one of the above-described date and time, place, environment, or behavior performed by the user of when the user has listened to the music can be specified, the ambiguity solving unit 105 can specify another date and time, place, environment, or behavior by referring to the life-log information of the user. For example, in a case where the date and time of when the user has listened to the music can be specified, the ambiguity solving unit 105 can specify a place of the user, environment, or behavior of the user at the date and time by referring to the life-log information. Also, in a case where the place of when the user has listened to the music can be specified, the ambiguity solving unit 105 can specify a date and time, environment, or behavior of the user at the place by referring to the life-log information.

On the basis of the music specifying information generated by the ambiguity solving unit 105, the music determination unit 107 determines at least one piece of music reproduction of which is estimated to be instructed by the user. Specifically, the music determination unit 107 can determine at least one piece of music, reproduction of which is estimated to be instructed by the user, from the music specifying information that specifies any one or more of the date and time, place, environment, or behavior performed by the user of when the user has listened to the music.

Note that the music determination unit 107 can also determine a music group reproduction of which is estimated to be instructed by the user. For example, the music determination unit 107 may determine a music group included in an album reproduction of which is estimated to be instructed by the user, a music group of an artist reproduction of which is estimated to be instructed by the user, or a music group suitable for an atmosphere reproduction of which is estimated to be instructed by the user.

For example, the music determination unit 107 may determine the music, reproduction of which is instructed by the user, by extracting a part of a melody of the music from sound information of an environment which information is included in the information related to the environment of when the user has listened to the music, and by collating the extracted melody with a music database. Also, the music determination unit 107 may determine the music, reproduction of which is instructed by the user, by extracting a title name or an artist name of the music from the sound information of the environment which information is included in the information related to the environment of when the user has listened to the music. Furthermore, the music determination unit 107 may determine the music, reproduction of which is instructed by the user, by extracting a jacket image of an album or the like including the music from image information of the environment which information is included in the information related to the environment of when the user has listened to the music.

In addition, for example, the music determination unit 107 may determine the music, reproduction of which is instructed by the user, by specifying content related to the music from the date and time, place, environment, or behavior performed by the user of when the user has listened to the music, and by referring to information related to the specified content. That is, the music determination unit 107 may specify the media (such as television program, commercial, or movie) that ties up with the music from the date and time, place, environment, or behavior performed by the user of when the user has listened to the music, and may determine the music, reproduction of which is instructed by the user, from tie-up information of the specified media. Alternatively, the music determination unit 107 may specify an event or live show in which the music is used from the date and time, place, environment, or behavior performed by the user of when the user has listened to the music, and may determine the music, reproduction of which is instructed by the user, from information of the specified event or live show.

Note that the music determination unit 107 may determine the music, reproduction of which is instructed by the user, by using a plurality of routes of information. This is because the pieces of information that are the date and time, place, environment, and behavior performed by the user of when the user has listened to the music and that are included in the music specifying information are associated with each other, and a plurality of routes in which the music determination unit 107 determines the music reproduction of which is instructed by the user is conceivable. The music determination unit 107 can determine the music, reproduction of which is instructed by the user, with higher accuracy by using the plurality of routes of information.

According to the ambiguity solving unit 105 and music determination unit 107 described above, it is possible to determine the music, reproduction of which is estimated to be instructed by the user, from utterance of the user in the following manner.

For example, from the expression that includes the ambiguity of “the theme song of the drama I watched yesterday” and that is included in the utterance of the user, the ambiguity solving unit 105 can specify the time when the drama has been watched from a behavior history of the user. Thus, the music determination unit 107 can determine the music corresponding to “the theme song of the drama I watched yesterday” by collating a melody of the music included in the sound information around the user at the specified time with the music database.

Alternatively, as another method, from the expression that includes the ambiguity of “the theme song of the drama I watched yesterday” and that is included in the utterance of the user, the ambiguity solving unit 105 can specify, from a post history on the SNS, a title name of the drama watched by the user. Thus, the music determination unit 107 can determine the music corresponding to “the theme song of the drama I watched yesterday” by referring to a tie-up information database from the title name of the drama.

For example, from expression that includes ambiguity of “the song played at the supermarket earlier” and that is included in the utterance of the user, the ambiguity solving unit 105 can specify the time when the user has been present in the supermarket from the positional information of the user or geographical category information of a map. Thus, the music determination unit 107 can determine the music corresponding to “the music played at the supermarket earlier” by collating a melody of the music included in the sound information around the user at the specified time with the music database.

For example, from expression that includes ambiguity of “the song played at the beginning in the live show last month” and that is included in the utterance of the user, the ambiguity solving unit 105 can specify the live show in which the user has participated from the positional information of the user and the event information. Thus, the music determination unit 107 can determine the music corresponding to “the song played at the beginning in the live show last month” by referring to a live information database for information of a set list in the specified live.

In such a manner, by using utterance including ambiguous expression of the user, the information processing device 10 according to the present embodiment can specify music that the user has listened to in the past and that is designated by the utterance. Thus, according to the information processing device 10 of the present embodiment, even when a song title or the like of the music listened to in the past is unknown, the user can cause the information processing device 10 to specify the music by uttering a situation in which the music has been listened to.

<3. Modification Example>

Next, a modification example of the information processing device 10 according to the present embodiment will be described. An information processing device 10 according to the present modification example is a modification example in which determination of music is enabled by an interaction with a user in a case where an ambiguity solving unit 105 cannot generate music specifying information or a music determination unit 107 cannot determine music reproduction of which is estimated to be instructed by the user.

For example, a music presentation unit that presents, in a case where the music determination unit 107 cannot narrow down pieces of music reproduction of which is estimated to be instructed by the user into one piece and determines a plurality of pieces thereof, each of title names of the determined pieces of music to the user may be further provided. In such a case, by presenting each of the title names of the candidate pieces of music, reproduction of which is estimated to be instructed by the user, to the user via a sound or image output from a terminal device 20, the music presentation unit can cause the user to specify the music instructed to be reproduced. At this time, the music presentation unit may present each of the title names of the candidate pieces of music, reproduction of which is estimated to be instructed by the user, to the user without weighting, or may perform presentation thereof to the user with weighting in descending order of reliability.

Also, a question generation unit that generates a question for the user to specify music in a case where the ambiguity solving unit 105 cannot generate the music specifying information or the music determination unit 107 cannot determine the music reproduction of which is estimated to be instructed by the user may be further provided. In such a case, the question generation unit can generate a question to confirm the user about a more detailed situation in which the music is listened to, and can output the generated question to the user via a sound or image output from the terminal device 20. This makes it possible for the ambiguity solving unit 105 and the music determination unit 107 to additionally acquire information that enables generation of the music specifying information and determination of the music.

<4. Operation of Information Processing Device>

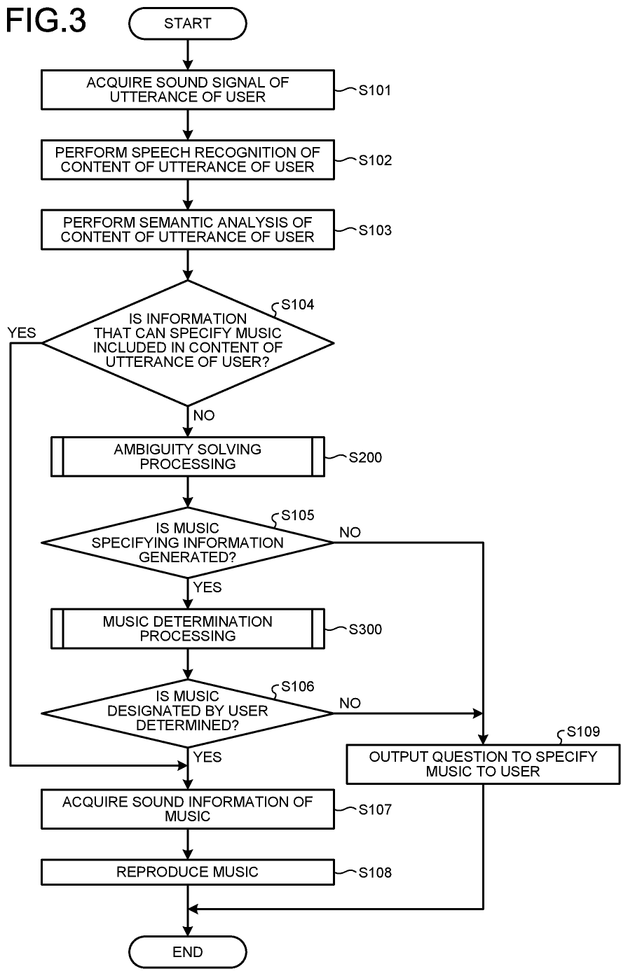

Next, an example of an operation of the information processing system 1 according to the present embodiment will be described with reference to FIG. 3 to FIG. 5.

(4.1. Overall Operation)

First, an example of an overall operation of the information processing system 1 according to the present embodiment will be described with reference to FIG. 3. FIG. 3 is a flowchart illustrating a flow of the overall operation of the information processing system 1 according to the present embodiment.

As illustrated in FIG. 3, first, a sound signal of utterance of a user is acquired by the terminal device 20 (S101), and the acquired sound signal is transmitted to the information processing device 10. Note that the utterance of the user which utterance is acquired at this time is to instruct reproduction of music.

Then, the information processing device 10 converts the utterance of the user from the sound signal into character information by performing speech recognition of the utterance of the user in the speech recognition unit 101 (S102). Subsequently, by performing a semantic analysis of the utterance of the user in the semantic analysis unit 103 (S103), the information processing device 10 analyzes what is intended by the utterance of the user.

Here, the information processing device 10 determines whether information that can clearly specify music is included in contents of the utterance of the user (S104). Note that the information that can clearly specify the music is, for example, a title name, artist name, and the like of the music. In a case where the information that can clearly specify the music is included in the contents of the utterance of the user (S104/Yes), the information processing device 10 notifies the terminal device 20 of the music, reproduction of which is determined to be instructed by the user, without the ambiguity solving unit 105 and the music determination unit 107.

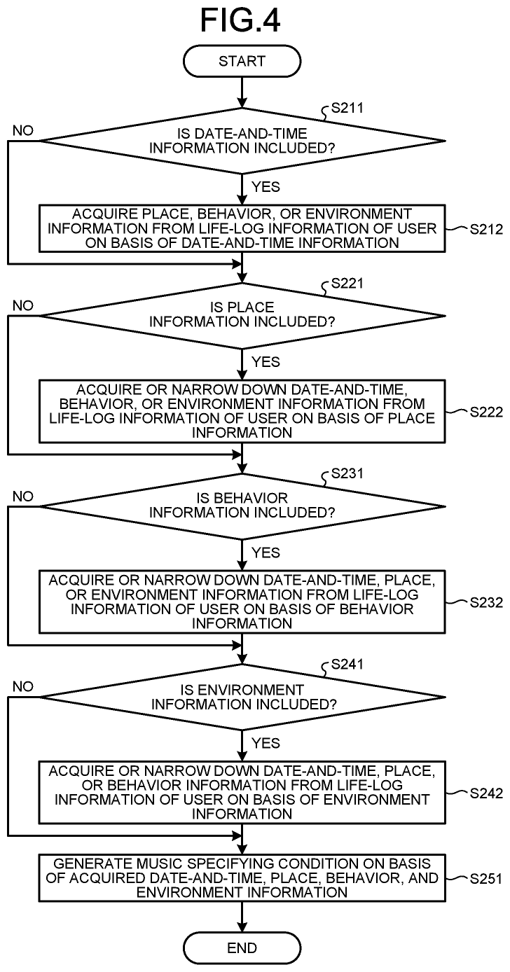

On the other hand, in a case where the information that can clearly specify the music is not included in the contents of the utterance of the user (S104/No), the information processing device 10 generates the music specifying information by executing ambiguity solving processing in the ambiguity solving unit 105 (S200) and interpreting contents of expression that includes ambiguity and that is included in the contents of the utterance of the user. A specific flow of the ambiguity solving processing will be described later with reference to FIG. 4.

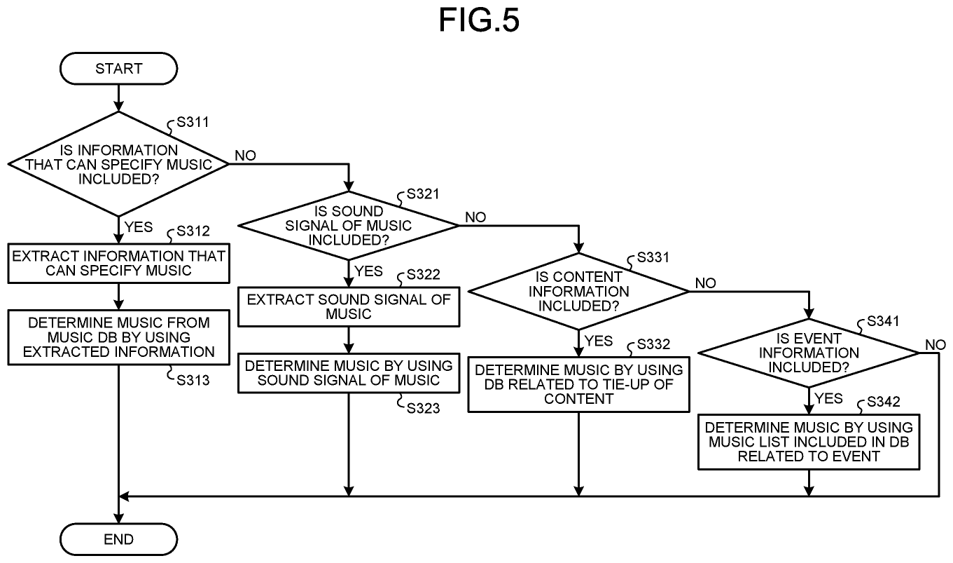

Then, the information processing device 10 determines whether the music specifying information is generated in the ambiguity solving unit 105 (S105), and the music determination unit 107 executes music determination processing (S300) and determines music, reproduction of which is estimated to be instructed by the user, in a case where the music specifying information is generated (S105/Yes). A specific flow of the music determination processing will be described later with reference to FIG. 5.

Subsequently, the information processing device 10 determines whether the music determination unit 107 can determine the music reproduction of which is estimated to be instructed by the user (S106). In a case where the music reproduction of which is estimated to be instructed by the user can be determined (S106/Yes), the information processing device 10 notifies the terminal device 20 of the music reproduction of which is determined to be instructed by the user.

The terminal device 20 notified of the music reproduction of which is determined to be instructed by the user can acquire sound information of the music from the music DB storage unit 400 or the like (S107), and reproduce the music by using the acquired sound information (S108).

Here, in a case where the ambiguity solving unit 105 cannot generate the music specifying information (S105/No), or in a case where the music determination unit 107 cannot determine the music reproduction of which is estimated to be instructed by the user (S106/No), the information processing device 10 may generate a question to specify the music and may output the generated question to the user via the terminal device 20 (S109). The question to specify the music is, for example, a question to draw additional information from the user by checking a more detailed situation in which the user has listened to the music, or by presenting a plurality of candidates of the situation in which the user has listened to the music. The information processing device 10 may determine the music, reproduction of which is estimated to be instructed by the user, through such an interaction between the user and the terminal device 20.

(4.2. Operation of Ambiguity Solving Processing)

Next, a specific flow of the ambiguity solving processing illustrated in FIG. 3 will be described with reference to FIG. 4. FIG. 4 is a flowchart illustrating the specific flow of the ambiguity solving processing illustrated in FIG. 3.

As illustrated in FIG. 4, first, the ambiguity solving unit 105 determines whether information related to a date and time is included in the utterance of the user (S211). In a case where the information related to the date and time is included (S211/Yes), the ambiguity solving unit 105 acquires information, which is related to a place, behavior, or environment and which corresponds to the information, from the life-log information of the user on the basis of the information that is related to the date and time and that is included in the utterance of the user (S212). In a case where the information related to the date and time is not included (S211/No), the ambiguity solving unit 105 skips Step S212.

Then, the ambiguity solving unit 105 determines whether information related to the place is included in the utterance of the user (S221). In a case where the information related to the place is included (S221/Yes), the ambiguity solving unit 105 acquires information, which is related to the date and time, behavior, or environment and which corresponds to the information, from the life-log information of the user on the basis of the information that is related to the place and that is included in the utterance of the user (S222). Also, in a case where the information that is related to the date and time, place, behavior, or environment and that is included in the utterance of the user is already acquired in Step S212, the ambiguity solving unit 105 may further narrow down, on the basis of the information that is related to the place and that is included in the utterance of the user, the information that is related to the date and time, place, behavior, or environment and that is acquired in Step S212. In a case where the information related to the place is not included (S221/No), the ambiguity solving unit 105 skips Step S222.

Subsequently, the ambiguity solving unit 105 determines whether information related to the behavior of the user is included in the utterance of the user (S231). In a case where the information related to the behavior is included (S231/Yes), the ambiguity solving unit 105 acquires information, which is related to the date and time, place, or environment and which corresponds to the information, from the life-log information of the user on the basis of the information that is related to the behavior and that is included in the utterance of the user (S232). Also, in a case where the information that is related to the date and time, place, behavior, or environment and that is included in the utterance of the user is already acquired in Step S212 or S222, the ambiguity solving unit 105 may further narrow down the information, which is related to the date and time, place, behavior, or environment and which is acquired in Step S212 or S222, on the basis of the information that is related to the behavior and that is included in the utterance of the user. In a case where the information related to the behavior is not included (S231/No), the ambiguity solving unit 105 skips Step S232.

Furthermore, the ambiguity solving unit 105 determines whether information related to the environment around the user is included in the utterance of the user (S241). In a case where the information related to the environment is included (S241/Yes), the ambiguity solving unit 105 acquires information, which is related to the date and time, place, or behavior of the user and which corresponds to the information, from the life-log information of the user on the basis of the information that is related to the environment and that is included in the utterance of the user (S242). Also, in a case where the information that is related to the date and time, place, behavior, or environment and that is included in the utterance of the user is already acquired in Step S212, S222, or S232, the ambiguity solving unit 105 may further narrow down, on the basis of the information that is related to the environment and that is included in the utterance of the user, the information that is related to the date and time, place, behavior, or environment and that is acquired in Step S212, S222, or S232. In a case where the information related to the environment is not included (S241/No), the ambiguity solving unit 105 skips Step S242.

Then, by integrating the information that is related to the date and time, place, behavior, or environment and that is acquired in Step S212, S222, S232, or S242 described above, the ambiguity solving unit 105 generates music specifying information to specify music reproduction of which is estimated to be instructed by the user (S251). The music specifying information is information that enables to specify music, reproduction of which is estimated to be instructed by the user, on the basis of an experience of the user.

For example, in the utterance of “the song of when a sound is suddenly made during payment at the cash register of the cafe in the yesterday evening”, the ambiguity solving unit 105 can specify the date and time of occurrence of the experience of the user from the information of “yesterday evening” which information is related to the date and time. Then, from the information of the “cafe” which information is related to the place, the ambiguity solving unit 105 can further limit the timing of occurrence of the experience of the user to the timing at which the user has been in the cafe. Subsequently, from the information of “during payment at the cash register” which information is related to the behavior, the ambiguity solving unit 105 can further limit the timing of occurrence of the experience of the user to the timing at which the user has been paying at the cash register of the cafe. In addition, from the information of “when a sound is suddenly made” which information is related to the environment, the ambiguity solving unit 105 can further limit the timing of occurrence of the experience of the user to the timing at which the unexpected sound has been made.

In such a manner, the ambiguity solving unit 105 can more promptly grasp what is meant by the ambiguous expression included in the utterance of the user by interpreting the ambiguity, which is based on the experience of the user, in order of elements that can easily specify the situation, for example, in order of the date and time, place, behavior of the user, and environment around the user.

(4.3. Operation of Music Determination Processing)

Next, a specific flow of the music determination processing illustrated in FIG. 3 will be described with reference to FIG. 5. FIG. 5 is a flowchart illustrating the specific flow of the music determination processing illustrated in FIG. 3.

As illustrated in FIG. 5, first, the music determination unit 107 determines whether information that can specify music is included in the information that is related to the date and time, place, behavior of the user, or environment and that is included in the music specifying information (S311). For example, the music determination unit 107 may determine whether the sound or image information of the environment around the user includes a title name, artist name, image of a package, or the like of the music which name or image can specify the music. In a case where the music specifying information includes the information that can specify the music (S311/Yes), the music determination unit 107 extracts the above-described information that can specify the music (S312). Then, by using the extracted information, the music determination unit 107 can determine the music, reproduction of which is estimated to be instructed by the user, from the music DB storage unit 400 (S313).

On the other hand, in a case where the music specifying information does not include the information that can specify the music (S311/No), the music determination unit 107 first determines whether a part of a sound signal of the music (that is, melody of the music) is included in the sound information of the environment around the user (S321). In a case where a part of the sound signal of the music is included in the sound information of the environment around the user (S321/Yes), the music determination unit 107 extracts the part of the sound signal of the music (S322). Then, after performing signal processing such as noise reduction, by using the extracted sound signal of the music, the music determination unit 107 can determine the music, reproduction of which is estimated to be instructed by the user, by making inquiries of the music DB storage unit 400 about music having a corresponding sound signal (S323).

Also, in a case where a part of the sound signal of the music is not included in the sound information of the environment around the user (S321/No), the music determination unit 107 determines whether the music specifying information includes information related to content that ties up with the music (S331). In a case where the music specifying information includes the information related to the content that ties up with the music (S331/Yes), the music determination unit 107 can determine the music, reproduction of which is estimated to be instructed by the user, by referring to a database related to the tie-up by using the information related to the content that ties up with the music (S332).

Furthermore, in a case where the music specifying information does not include the information related to the content that ties up with the music (S331/No), the music determination unit 107 determines whether event information related to the music is included in the music specifying information (S341). In a case where the music specifying information includes the event information related to the music (S341/Yes), the music determination unit 107 can determine the music, reproduction of which is estimated to be instructed by the user, by referring to a database related to an event by using the event information related to the music (S342).

In such a manner, the music determination unit 107 can determine the music, reproduction of which is estimated to be instructed by the user, in order in which the music is easily specified, for example, in order of the information such as a title name or the like of the music which information can specify the music, a sound signal (that is, melody) of the music, and the information of the content or event related to the music.

As the flow of the operation is described above, the information processing device 10 according to the present embodiment can specify, from the utterance including the ambiguous expression of the user, music designated by the utterance. Thus, according to the information processing device 10 of the present embodiment, it is possible to determine the music to be reproduced by reading intention of the user even from the ambiguous utterance of the user which utterance is based on the experience.

<5. Hardware Configuration>

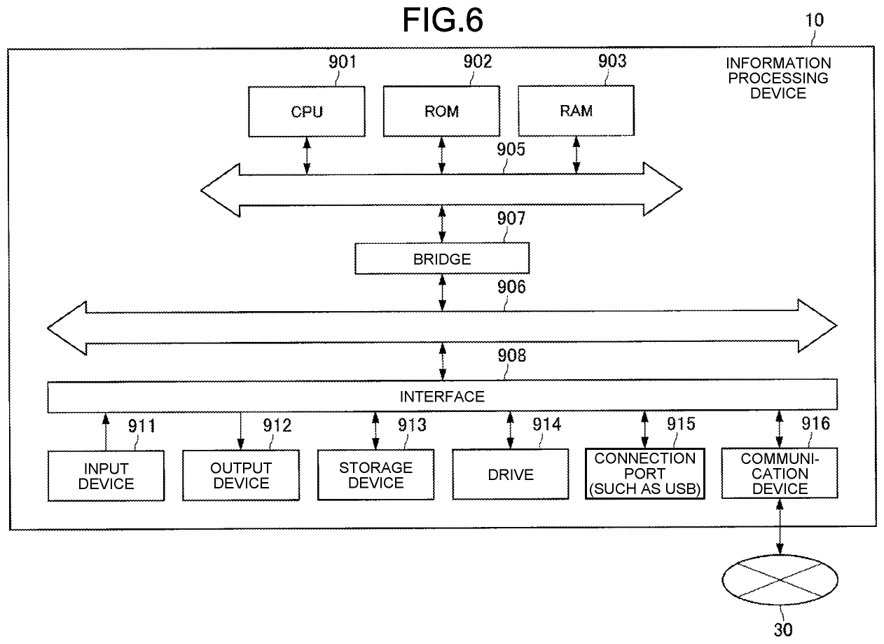

Here, an example of a hardware configuration of the information processing device 10 included in the information processing system 1 according to the present embodiment will be described with reference to FIG. 6. FIG. 6 is a block diagram illustrating the example of the hardware configuration in the information processing device 10 included in the information processing system 1 according to the present embodiment.

As illustrated in FIG. 6, the information processing device 10 includes a CPU 901, a ROM 902, a RAM 903, a host bus 905, a bridge 907, an external bus 906, an interface 908, an input device 911, an output device 912, a storage device 913, a drive 914, a connection port 915, and a communication device 916. The information processing device 10 may include a processing circuit such as an electric circuit, a digital signal processor (DSP), or an application specific integrated circuit (ASIC) instead of the CPU 901 or together with the CPU 901.

The CPU 901 functions as an arithmetic processing device or a control device, and controls overall operation of the information processing device 10 according to various kinds of programs. The ROM 902 stores programs, operation parameters, and the like used by the CPU 901, and the RAM 903 temporarily stores programs used in execution of the CPU 901, parameters that appropriately change in the execution, and the like. The CPU 901 may execute, for example, the functions of the speech recognition unit 101, the semantic analysis unit 103, the ambiguity solving unit 105, and the music determination unit 107.

The CPU 901, the ROM 902, and the RAM 903 are connected to each other by the host bus 905 including a CPU bus and the like. The host bus 905 is connected to the external bus 906 such as a peripheral component interconnect/interface (PCI) bus via the bridge 907. Note that the host bus 905, the bridge 907, and the external bus 906 are not necessarily separated, and the functions thereof may be mounted on one bus.

The input device 911 is a device to which information is input by the user, and which is a mouse, keyboard, touch panel, button, microphone, switch, lever, or the like, for example. The input device 911 may include, for example, the above-described input means, and an input control circuit that generates an input signal on the basis of the information input by the user with the above-described input means.

The output device 912 is a device capable of visually or aurally outputting information to the user. For example, the output device 912 may be a display device such as a cathode ray tube (CRT) display device, a liquid-crystal display device, a plasma display device, an electroluminescence (EL) display device, a laser projector, a light emitting diode (LED) projector, or a lamp, or may be a sound output device such as a speaker or headphone, or the like.

The output device 912 may output, for example, information acquired by various kinds of processing by the information processing device 10. Specifically, the output device 912 may visually display the information, which is acquired by the various kinds of processing by the information processing device 10, in various forms such as a text, image, table, or graph. Alternatively, the output device 912 may convert an audio signal such as sound data or acoustic data acquired by the various kinds of processing by the information processing device 10 into an analog signal and perform an aural output thereof.

The storage device 913 is a device that is for data storage and that is formed as an example of a storage unit of the information processing device 10. The storage device 913 may be realized, for example, by a magnetic storage device such as a hard disk drive (HDD), a semiconductor storage device, an optical storage device, a magneto-optical storage device, or the like. For example, the storage device 913 may include a storage medium, a recording device that records data into the storage medium, a reading device that reads data from the storage medium, a deletion device that deletes data recorded in the storage medium, and the like. Furthermore, the storage device 913 may store programs executed by the CPU 901, various kinds of data, various kinds of data acquired from the outside, and the like. The storage device 913 may execute the function of the life-log accumulation unit 110, for example.

The drive 914 is a reader/writer for the storage medium, and is built in or externally attached to the information processing device 10. The drive 914 reads information recorded in a mounted removable storage medium such as a magnetic disk, optical disk, magneto-optical disk, or semiconductor memory, and perform an output thereof to the RAM 903. Also, the drive 914 can write information into the removable storage medium.

The connection port 915 is an interface connected to an external device. The connection port 915 is a connection port capable of transmitting data to the external device, and may be a universal serial bus (USB), for example.

The communication device 916 is, for example, an interface formed of a communication device or the like for connection to the network 30. The communication device 916 may be, for example, a communication card for a wired or wireless local area network (LAN), long term evolution (LTE), Bluetooth (registered trademark), or a wireless USB (WUSB), or the like. Also, the communication device 916 may be a router for optical communication, a router for an asymmetric digital subscriber line (ADSL), a modem for various kinds of communication, or the like. On the basis of a predetermined protocol such as TCP/IP, the communication device 916 can transmit/receive a signal or the like to/from the Internet or another communication equipment, for example.

Note that a computer program to cause the hardware such as the CPU, ROM, and RAM built in the information processing device 10 to perform functions equivalent to those of the configurations of the information processing device 10 included in the information processing system 1 according to the present embodiment described above can be also created. Also, it is possible to provide a storage medium that stores the computer program.

A preferred embodiment of the present disclosure has been described in detail in the above with reference to the accompanying drawings. However, the technical scope of the present disclosure is not limited to such an example. It is obvious that a person having ordinary knowledge in the technical field of the present disclosure can conceive various alterations or modifications within the scope of the technical idea described in the claims, and it should be understood that these alterations or modifications naturally belong to the technical scope of the present disclosure.

For example, in the above embodiment, the technology according to the present disclosure is used to determine music reproduction of which is estimated to be instructed by the user. However, the present technology is not limited to such an example. For example, the technology according to the present disclosure can also be applied to a case of searching for various kinds of information on the basis of utterance including ambiguity based on experience of the user. Specifically, from utterance including ambiguity based on experience of the user, the technology according to the present disclosure can also determine a store, destination, technical term, content (such as movie, television program, novel, game, or cartoon), or the like specified by the utterance of the user by referring to life-log information of the user.

In addition, the effects described in the present specification are merely illustrative or exemplary, and are not restrictive. That is, in addition to the above effects or instead of the above effects, the technology according to the present disclosure can exhibit a different effect obvious to those skilled in the art from the description of the present specification.

Note that the following configurations also belong to the technical scope of the present disclosure.
(1)

An information processing device comprising:

an ambiguity solving unit that generates music specifying information from information, which is included in utterance of a user and which includes ambiguity based on experience, by using sensing information related to the user; and

a music determination unit that determines, on the basis of the music specifying information, at least one piece of music reproduction of which is estimated to be instructed by the utterance by the user.
(2)

The information processing device according to (1), wherein the music specifying information is information to specify a situation in which the user listens to the music reproduction of which is estimated to be instructed by the user.
(3)

The information processing device according to (2), wherein the situation in which the user listens to the music includes any one or more of a date and time, place, environment, or behavior performed by the user of when the user listens to the music.
(4)

The information processing device according to (3), wherein the ambiguity solving unit generates the music specifying information by specifying the situation in which the user listens to the music in order of the date and time, place, behavior performed by the user, and environment.
(5)

The information processing device according to (4), wherein by referring to the sensing information on a basis of one piece of information that specifies the situation in which the user listens to the music, the ambiguity solving unit further generates other information that specifies the situation in which the user listens to the music.
(6)

The information processing device according to any one of (1) to (5), wherein the music specifying information to specify environment of when the user listens to the music includes sound information of the environment of when the user listens to the music, and

the music determination unit determines the music by using a part of a sound of the music which sound is included in the sound information of the environment.
(7)

The information processing device according to any one of (1) to (6), wherein the music specifying information to specify environment of when the user listens to the music includes sound information or image information of the environment of when the user listens to the music, and

the music determination unit determines the music by using any one or more of a title name or an artist name of the music included in the sound information or image information of the environment.
(8)

The information processing device according to any one of (1) to (7), wherein the music determination unit determines, on a basis of the music specifying information, content related to the music reproduction of which is estimated to be instructed by the user, and determines the music by using the content related to the music.
(9)

The information processing device according to (8), wherein the content related to the music is content that ties up with the music, or an event or live show using the music.
(10)

The information processing device according to any one of (1) to (9), wherein the music determination unit determines, on a basis of each of different pieces of the music specifying information, the music reproduction of which is estimated to be instructed by the user.
(11)

The information processing device according to any one of (1) to (10), further comprising a music presentation unit that presents a title name of the at least one piece of music determined by the music determination unit to the user.
(12)

The information processing device according to (11), wherein the music presentation unit presents the title name of the at least one piece of music determined by the music determination unit to the user in descending order of reliability.
(13)

The information processing device according to any one of (1) to (12), further comprising a question generation unit that generates a question to the user, the question being to specify the music, in a case where the ambiguity solving unit cannot generate the music specifying information or the music determination unit cannot determine the music.
(14)

The information processing device according to any one of (1) to (13), wherein the sensing information is life-log information of the user in which information a history of at least one of information related to a position of the user, information related to behavior of the user, or information related to an environment around the user is accumulated.
(15)

The information processing device according to (14), wherein the life-log information is information acquired by at least any one of an information processing terminal carried by the user or a sensor that senses a space in which the user is present.
(16)

An information processing method comprising:

generating music specifying information from information, which is included in utterance of a user and which includes ambiguity based on experience, by using sensing information related to the user; and

determining, on a basis of the music specifying information, at least one piece of music reproduction of which is estimated to be instructed by the utterance by the user,

the generating and determining being performed by an arithmetic device.
(17)

A program causing a computer to function as

an ambiguity solving unit that generates music specifying information from information, which is included in utterance of a user and which includes ambiguity based on experience, by using sensing information related to the user, and

a music determination unit that determines, on a basis of the music specifying information, at least one piece of music reproduction of which is estimated to be instructed by the utterance by the user.

### REFERENCE SIGNS LIST

1 INFORMATION PROCESSING SYSTEM
10 INFORMATION PROCESSING DEVICE
20 TERMINAL DEVICE
21 SMARTPHONE
22 SMART SPEAKER
23 EARPHONE
30 NETWORK
40 DATABASE SERVER
101 SPEECH RECOGNITION UNIT
103 SEMANTIC ANALYSIS UNIT
105 AMBIGUITY SOLVING UNIT
107 MUSIC DETERMINATION UNIT
110 LIFE-LOG ACCUMULATION UNIT
201 SPEECH INPUT UNIT
203 SOUND OUTPUT UNIT
205 MUSIC ACQUISITION UNIT
400 MUSIC DB STORAGE UNIT

1. An information processing device comprising:
an ambiguity solving unit that generates music specifying information from information, which is included in utterance of a user and which includes ambiguity based on experience, by using sensing information related to the user; and
a music determination unit that determines, on the basis of the music specifying information, at least one piece of music reproduction of which is estimated to be instructed by the utterance by the user.

2. The information processing device according to claim 1, wherein the music specifying information is information to specify a situation in which the user listens to the music reproduction of which is estimated to be instructed by the user.

3. The information processing device according to claim 2, wherein the situation in which the user listens to the music includes any one or more of a date and time, place, environment, or behavior performed by the user of when the user listens to the music.

4. The information processing device according to claim 3, wherein the ambiguity solving unit generates the music specifying information by specifying the situation in which the user listens to the music in order of the date and time, place, behavior performed by the user, and environment.

5. The information processing device according to claim 4, wherein by referring to the sensing information on a basis of one piece of information that specifies the situation in which the user listens to the music, the ambiguity solving unit further generates other information that specifies the situation in which the user listens to the music.

6. The information processing device according to claim 1, wherein the music specifying information to specify environment of when the user listens to the music includes sound information of the environment of when the user listens to the music, and
the music determination unit determines the music by using a part of a sound of the music which sound is included in the sound information of the environment.

7. The information processing device according to claim 1, wherein the music specifying information to specify environment of when the user listens to the music includes sound information or image information of the environment of when the user listens to the music, and
the music determination unit determines the music by using any one or more of a title name or an artist name of the music included in the sound information or image information of the environment.

8. The information processing device according to claim 1, wherein the music determination unit determines, on a basis of the music specifying information, content related to the music reproduction of which is estimated to be instructed by the user, and determines the music by using the content related to the music.

9. The information processing device according to claim 8, wherein the content related to the music is content that ties up with the music, or an event or live show using the music.

10. The information processing device according to claim 1, wherein the music determination unit determines, on a basis of each of different pieces of the music specifying information, the music reproduction of which is estimated to be instructed by the user.

11. The information processing device according to claim 1, further comprising a music presentation unit that presents a title name of the at least one piece of music determined by the music determination unit to the user.

12. The information processing device according to claim 11, wherein the music presentation unit presents the title name of the at least one piece of music determined by the music determination unit to the user in descending order of reliability.

13. The information processing device according to claim 1, further comprising a question generation unit that generates a question to the user, the question being to specify the music, in a case where the ambiguity solving unit cannot generate the music specifying information or the music determination unit cannot determine the music.

14. The information processing device according to claim 1, wherein the sensing information is life-log information of the user in which information a history of at least one of information related to a position of the user, information related to behavior of the user, or information related to an environment around the user is accumulated.

15. The information processing device according to claim 14, wherein the life-log information is information acquired by at least any one of an information processing terminal carried by the user or a sensor that senses a space in which the user is present.

16. An information processing method comprising:
generating music specifying information from information, which is included in utterance of a user and which includes ambiguity based on experience, by using sensing information related to the user; and
determining, on a basis of the music specifying information, at least one piece of music reproduction of which is estimated to be instructed by the utterance by the user,
the generating and determining being performed by an arithmetic device.

17. A program causing a computer to function as
an ambiguity solving unit that generates music specifying information from information, which is included in utterance of a user and which includes ambiguity based on experience, by using sensing information related to the user, and
a music determination unit that determines, on a basis of the music specifying information, at least one piece of music reproduction of which is estimated to be instructed by the utterance by the user.
